(19) United States
(12) Patent Application Publication
(10) Pub. No.: US 2009/0289080 A1
(43) Pub. Date: Nov. 26, 2009

(54) FLUID CONTAINER

(76) Inventor: Edward Jared Murray, Northport, NY (US)

Correspondence Address: F. CHAU & ASSOCIATES, LLC, 130 WOODBURY ROAD, WOODBURY, NY, 11797, US

(21) Appl. No.: 12/470,898

(22) Filed: May 22, 2009

Related U.S. Application Data
(60) Provisional application No. 61/055,675, filed on May 23, 2008.

(51) Int. Cl. B67D 5/64; B67D 5/378; B67D 3/00; B65D 35/38

(52) U.S. Cl. 222/175; 222/527; 222/568; 222/481.5

(57) ABSTRACT

A fluid container, comprising a bottom surface, four walls extending upward from the bottom surface to create a cavity to house a fluid, a top surface covering the cavity, a fluid opening formed in one of the four walls near the bottom surface, wherein the fluid passes through the fluid opening to exit the container, and an air/vapor passageway formed adjacent and substantially parallel to the one of the four walls including the fluid opening, wherein the air/vapor passageway extends from the fluid opening upward toward the top surface, and air/vapor passes through the passageway into the container.

### CROSS-REFERENCE TO RELATED APPLICATION

This application claims the benefit of U.S. Provisional Patent Application Ser. No. 61/055,675, filed on May 23, 2008, the contents of which are herein incorporated by reference in their entirety.

### BACKGROUND OF THE INVENTION

1. Technical Field

The present disclosure relates to a container for fluid, such as gasoline or water, and more specifically, a fluid container that is wearable on a user's back such that the container can be worn as a backpack, and includes a vapor recovery system.

2. Discussion of the Related Art

Known fluid containers, for example, five (5) or eight (8) gallon water or gasoline containers, can be very cumbersome and heavy to carry, especially when filled with fluid. Bearing weight on one's back is a more efficient and comfortable way to transport items. In addition, known fluid containers do not include effective vapor recovery systems.

Accordingly, there is a need for a fluid container that includes a vapor recovery system, and that is adapted to be worn on the back of a user to facilitate carrying of the container by a user.

### SUMMARY OF THE INVENTION

A fluid container, according to an embodiment of the present invention, comprises a bottom surface, four walls extending upward from the bottom surface to create a cavity to house a fluid, a top surface covering the cavity, a fluid opening formed in one of the four walls near the bottom surface, wherein the fluid passes through the fluid opening to exit the container, an air/vapor passageway formed adjacent and substantially parallel to the one of the four walls including the fluid opening, wherein the air/vapor passageway extends from the fluid opening upward toward the top surface, and air/vapor passes through the passageway into the container.

The air/vapor passageway may comprise an enclosed channel located on a surface of the one of the four walls, the enclosed channel including an entrance opening through which air/vapor enters the enclosed channel and an exit opening through which air/vapor exits the enclosed channel.

The exit opening may connect to a canal positioned at or near the top of the cavity and extending substantially parallel to the top surface, wherein the air/vapor travels through the canal into the cavity.

The fluid container may further comprise a hose connected to the fluid opening, wherein the hose includes an outer hose portion, an inner hose portion substantially concentric with the outer hose portion, and a space between an outer wall of the inner hose portion and an inner wall of the outer hose portion, wherein the fluid passes through the fluid opening to the inner hose portion, and the air/vapor passes through the space to the air/vapor passageway.

The fluid container may further comprise a plurality of spacers positioned between the outer and inner hose portions. The hose may include a dispensing end through which the fluid is dispensed, and a cone-shaped spout positioned at the dispensing end, wherein a smaller diameter portion of the cone-shaped spout is closer to the dispensing end than a larger diameter portion of the cone-shaped spout.

The fluid container may further comprise a valve to open and close the fluid opening. The valve may be a ball valve.

At least one of the four walls may extend higher than the top surface and the portion of the at least one of the four walls higher than the top surface may include an opening formed therein.

The fluid container may further comprise a plurality of shoulder straps attached thereto to allow a user to wear the container on the user's back.

The bottom surface may extend beyond an outer surface of at least one of the four walls.

A fluid container, according to an embodiment of the present invention, comprises a bottom surface, four walls extending upward from the bottom surface to create a cavity to house a fluid, a top surface covering the cavity, a fluid opening formed in one of the four walls near the bottom surface, wherein the fluid passes through the fluid opening to exit the container, an air/vapor passageway formed along the one of the four walls including the fluid opening, wherein the air/vapor passageway extends from the fluid opening upward toward the top surface, and air/vapor passes through the passageway into the container.

The air/vapor passageway may connect to a canal positioned at or near the top of the cavity and extending substantially parallel to the top surface, wherein the air/vapor travels through the canal into the cavity.

The fluid container may further comprise a hose connected to the fluid opening, wherein the hose includes an outer hose portion, an inner hose portion positioned in the outer hose portion, and a space between an outer wall of the inner hose portion and an inner wall of the outer hose portion, wherein the fluid passes through the fluid opening to the inner hose portion, and the air/vapor passes through the space to the air/vapor passageway.

### BRIEF DESCRIPTION OF THE DRAWINGS

Exemplary embodiments of the present invention will be described below in more detail, with reference to the accompanying drawings, of which:

FIG. 1 shows a perspective view of a wearable fluid container, according to an embodiment of the present invention;

FIG. 2 shows a left side view of a wearable fluid container, according to an embodiment of the present invention;

FIG. 3 shows a top view of a wearable fluid container, according to an embodiment of the present invention;

FIG. 4 shows a front view of a wearable fluid container, according to an embodiment of the present invention;

FIG. 5 shows a rear view of a wearable fluid container, according to an embodiment of the present invention;

FIG. 6 shows a side perspective view of a side panel including a first ball valve of a wearable fluid container, according to an embodiment of the present invention;

FIG. 7 shows a side perspective view of a side panel including a second ball valve and a vapor passageway of a wearable fluid container, according to an embodiment of the present invention;

FIG. 7A shows a schematic representation of a vapor passageway of a wearable fluid container, according to an embodiment of the present invention;

FIG. 8 shows a top sectional perspective view of a vapor passageway of a wearable fluid container, according to an embodiment of the present invention;

FIG. 9 shows a perspective view of a delivery hose of a wearable fluid container, including a cap and a spout, according to an embodiment of the present invention;

FIG. 10 is a sectional view of the cap and hose taken along the line 10-10 in FIG. 9, according to an embodiment of the present invention;

FIG. 11 is a sectional view of the spout and hose taken along the line 11-11 in FIG. 9, according to an embodiment of the present invention;

FIG. 12 is a front view of the cap positioned on the delivery hose of the wearable fluid container, according to an embodiment of the present invention;

FIG. 13 is a front view of the spout positioned on the delivery hose of the wearable fluid container, according to an embodiment of the present invention;

FIG. 14 is a side view of an inside bottom portion of the wearable fluid container, according to an embodiment of the present invention;

FIG. 15 is a sectional view of the cap and opening of the wearable fluid container, according to an embodiment of the present invention; and

FIG. 16 is a sectional view of the delivery hose including a spring-loaded handle operated valve of the wearable fluid container, according to an embodiment of the present invention.

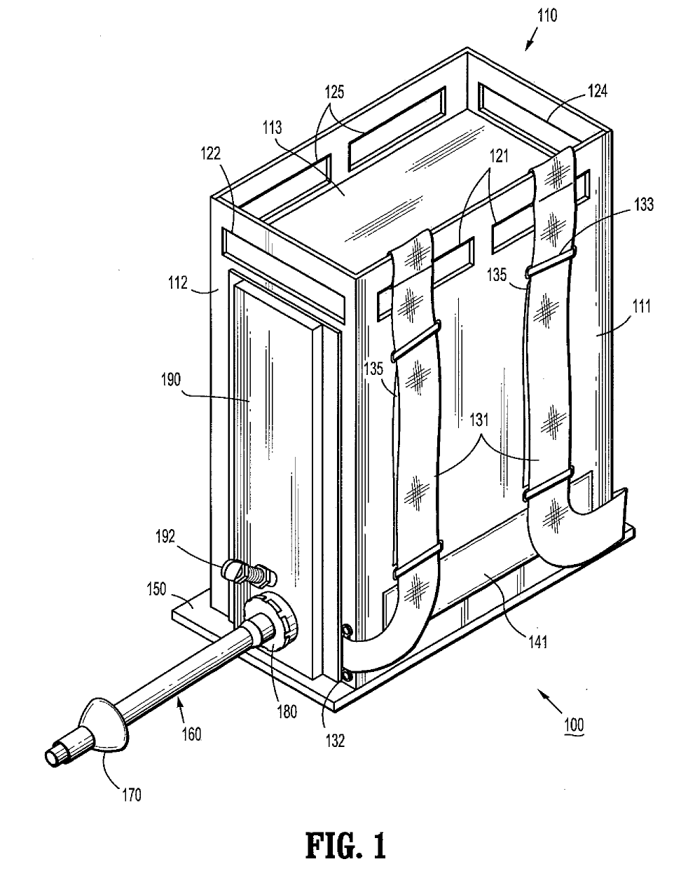

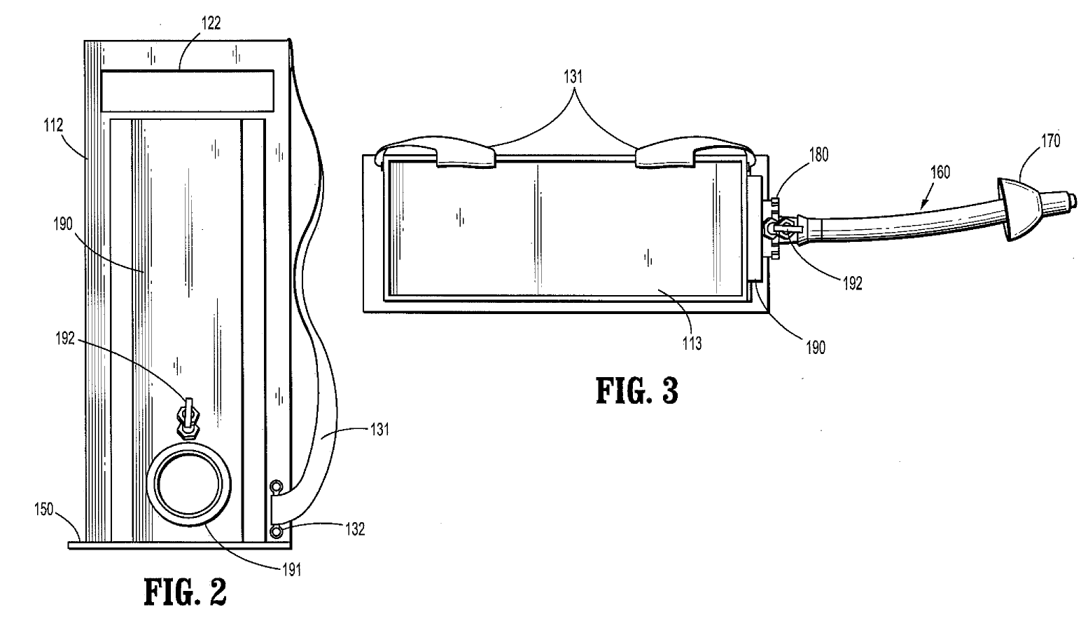

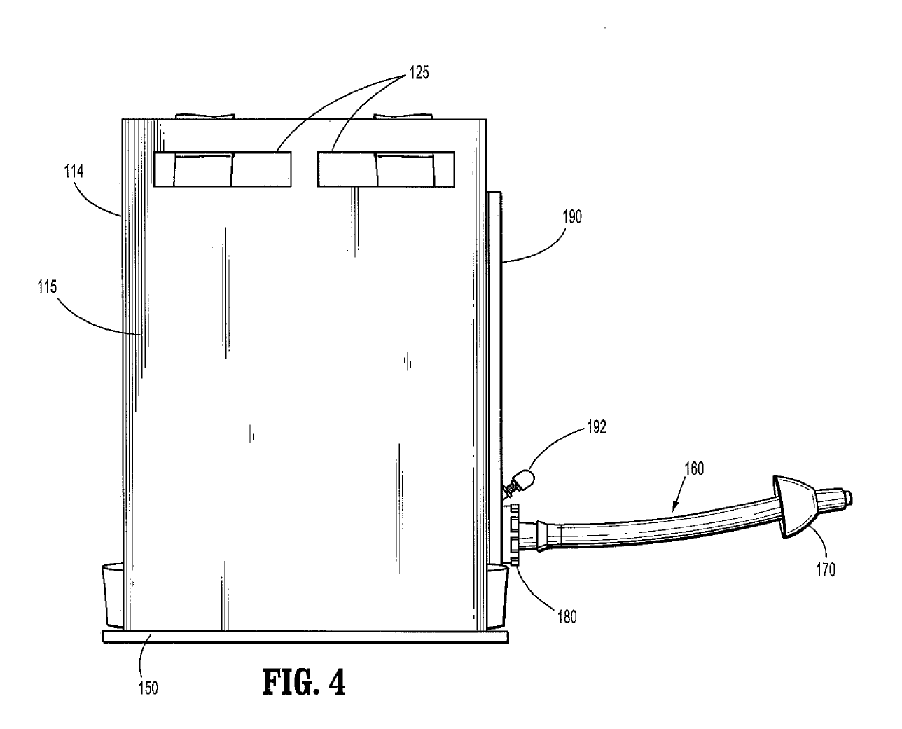

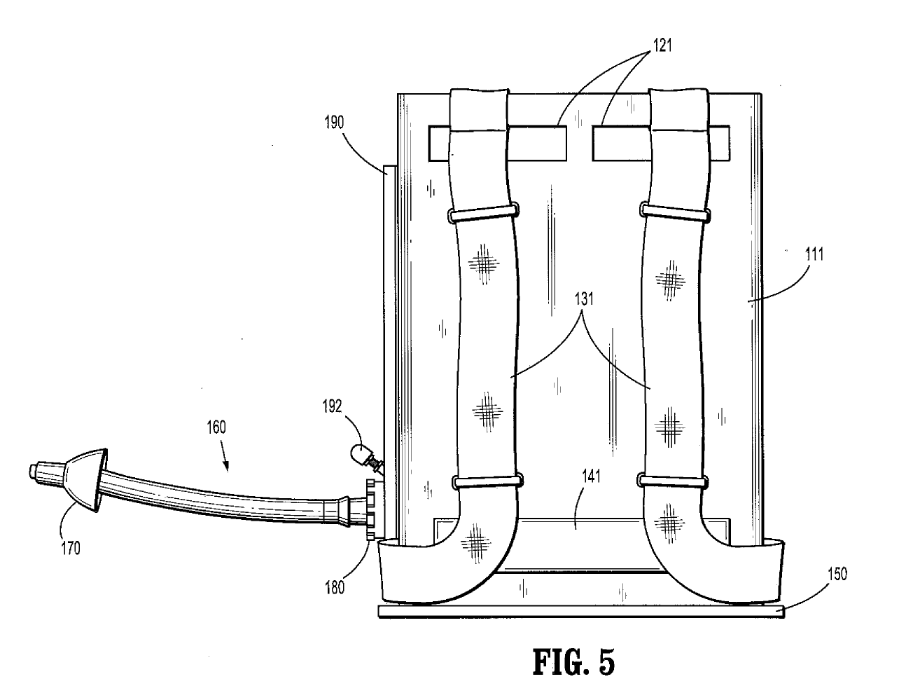

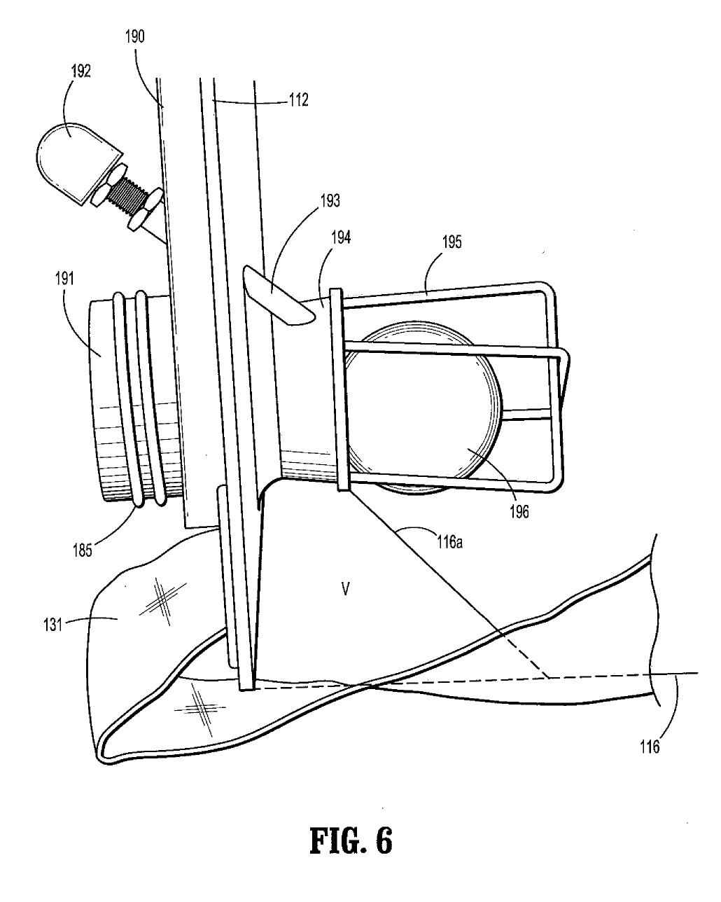

### DETAILED DESCRIPTION OF EXEMPLARY EMBODIMENTS

Exemplary embodiments of the present invention now will be described more fully hereinafter with reference to the accompanying drawings. This invention may, however, be embodied in many different forms and should not be construed as limited to the embodiments set forth herein.

Referring to the drawings, a fluid container 100 to carry fluid, such as gasoline or water, includes a housing 110. The housing 110 includes a back panel 111, a front panel 115, side panels 112 and 114, a top panel 113 and a bottom panel 116. The bottom inside of the container 100 may include a slight bevel 116a running from the bottom panel 116 to opening 191, creating a void V under the ball valve positioned on the side panel 112.

The panels 111, 112, 114 and 115 extend to a height over the top panel 113, and include respective openings 121, 122, 124 and 125 therein, which may be used as handles when not wearing the container 100 on one's back. The openings 121 also receive straps 131 to fix the straps 131 to an upper portion of the housing 110. The straps 131 are fixed to a lower portion of the housing 110 using strap supports 132 respectively located on side panels 112 and 114. The strap supports 132 can be molded to the housing 110 to create an opening between the strap support 132 and each panel 112 and 114, through which the straps 131 can pass and be fixed to the lower portion of the housing 110.

Users pass their arms through the straps 131 to position the straps 131 around their shoulders so that the hack panel 111 rests against a user's back and the container 100 is worn as a backpack. The back panel 111 includes a pad 141 which can conform to a user's lower back for added comfort and support. The pad 141 may be made from any suitable material, such as nylon, and can include foam material inside the pad 141. The straps 131 can be made of any suitable material, such as nylon, and may be padded for added comfort. In addition, the straps 131 may include external pads 135 for comfort and adjustment bars 133 for quick release and/or size adjustment of the straps 131 to accommodate different users.

The container 100 includes a base 150 that is wider than the housing 110 so as to provide a stable configuration when the container 100 rests on a surface, such as the ground, a table or a dock. Furthermore, the base 150 is wide enough to permit stable stacking of multiple containers 100 for storage and/or transport.

Depending on the intended use of the container 100, the container 100 may be made of different materials. For example, the container may be made of 3 mm or 4 mm high density polyethylene (HDPE), whereby the 3 mm HDPE can be used for water, and the 4 mm HDPE can be used for gasoline. In addition, for industrial or military use, other materials may be desirable, such as corrosion resistant 20 gauge steel. Also, as an alternative to being opaque, the housing 110 may be translucent or semi-translucent to allow a user to see the fluid level in the container 100. The housing 110 may also include molded markings to indicate the number of gallons or liters of fluid in the container 100.

The container includes an opening 191 formed in the side panel 112 through which the fluid from the container 100 is dispensed. The fluid can be dispensed directly through the opening 191. Alternatively, especially in the case of gasoline or other flammable liquids, where dispensing containers are governed by strict regulations, the fluid can be dispensed via a delivery hose or tube 160, including a cap 180 and a spout 170 at opposite ends thereof. The cap 180 is threaded with threads 185 and screws onto a mating threaded portion including threads 185 located at the opening 191. O-ring grooves 186 and 187 are located at interior portions of the cap 180 and opening 191, respectively. The O-ring grooves receive O-rings for creating a leak-proof seal between the cap 180 and opening 191 when the cap 180 is screwed onto the opening 191.

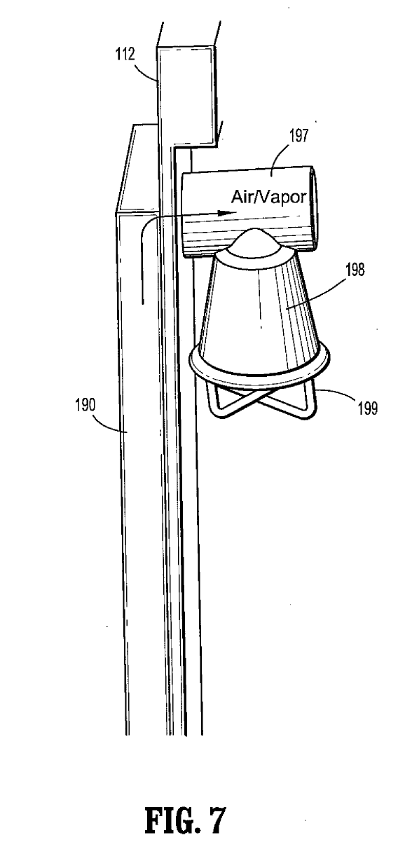

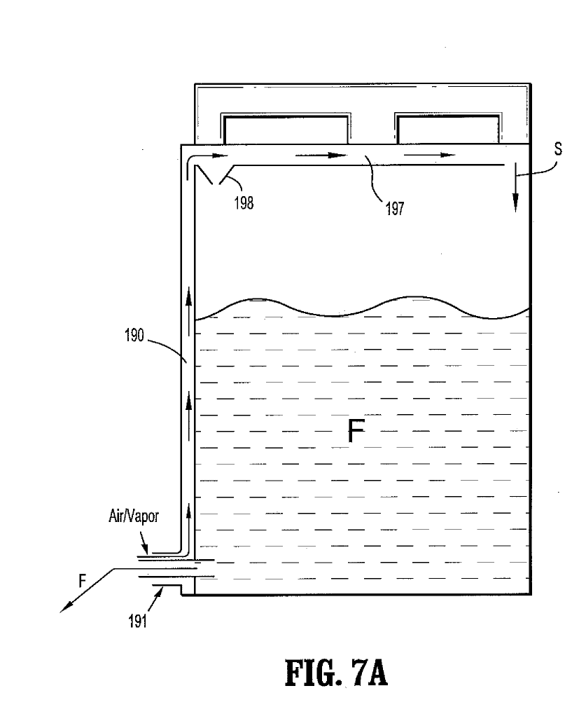

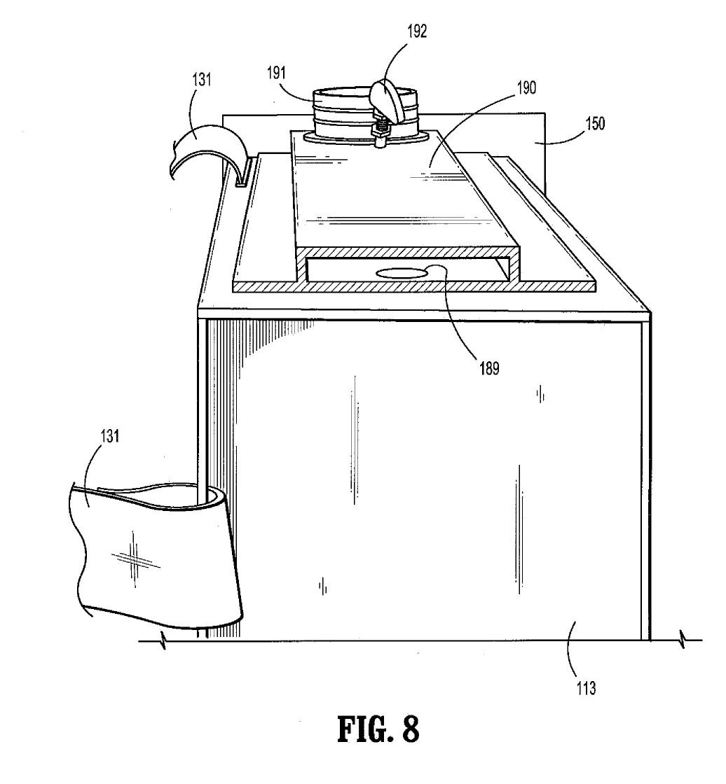

While delivering gasoline or other odorous and/or flammable liquid from the container, the hose 160; cap 180, spout 170, and container 100 include features to remove harmful vapors from the air surrounding the container, and to prevent overflow. For example, the hose 160 includes an outer hose 161 and an inner hose 162. When fluid, such as gasoline, is being poured out of the container 100 through the inner hose 162, vapor and air travel back into the container through the space between the outer wall of the inner hose 162 and the inner wall of the outer hose 161 to the vapor/air passageway 190 located on the side panel 112. In accordance with Venturi principles, a vacuum is created in the vapor passageway 190 while pouring the fluid out of the can, and air/vapor is sucked in through the space between the outer wall of the inner hose 162 and the inner wall of the outer hose 161 to the vapor/air passageway 190. In other words, referring to FIG. 7A, as the fuel F (or other liquid) comes out of the container, a suction S is caused to draw in air to pull vapor into the container. As the fuel F is pulled out of the container, and the empty space in the container increases, a suction S results. The air/vapor travels through the passageway 190, through opening 189 and into canal 197 inside the housing 110. The canal 197 includes an open end into the body of the container 100 at the end farthest from the opening 189. In addition, the canal 197 feeds into a body portion 198 of a ball valve to allow any fluid that entered into the passageway 190 to be returned to the body of the container 100.

The cap 180 includes a cone shaped portion 181 that fits into the opening 191 when the cap 180 is screwed onto the treaded portion of the opening 191. The cone shaped portion 181 includes holes 182 or other types of openings to create a porous section C through which the air/vapor can pass into the vapor/air passageway 190. The porous section C corresponds to the space between the outer wait of the inner hose 162 and the inner wall of the outer hose 161. The fluid travels out of the container 100 through the inner hose 162.

The outer hose 161 is prevented from collapsing or caving in on the inner hose 162 by separation rods 163, extending along the length of the hose 160 and positioned between the outer and inner hoses 161, 162. The separation rods 163 are made of a rigid or semi-rigid material, such as a bendable metal or hard rubber to provide support for the outer hose 161 and to act as a spacer between the outer and inner hoses 161, 162. Alternatively, or in addition to the separation rods 163, protrusions 164 may be positioned between the inner wall of the outer hose 161 and the outer wall of the inner hose 162. The protrusions 164 extend substantially perpendicular to the outer wall of the inner hose 162 and the inner wall of the outer hose 161. Like the separation rods 163, the protrusions 164 function as spacers between the outer and inner hoses 161, 162. The outer hose 161 and/or the inner hose 162 may be molded to include the protrusions 164 extending therefrom. Alternatively, the protrusions 164 can be wedged between the outer and inner hoses 161, 162.

The cone-shaped spout 170 fits around the outer wall of the outer hose 161, with the smaller diameter portion of the spout 170 being closer to the dispensing end of the hose. Accordingly, the spout 170 seals an opening (such as the opening for a gas tank in a vehicle) into which the fluid is being dispensed, and prevents overflow and splashing. The spout 170 also seals the opening so that vapors do not escape while dispensing odorous liquids, such as fuel. Furthermore, when the fluid reaches the top portion of the tank into which the fluid is being dispensed, the fluid in the tank covers the entrance for air into the space between the outer wall of the inner hose 162 and the inner wall of the outer hose 161, thereby stopping fluid flow out of the container 100 to prevent overflow (analogous to an end of a straw being sealed off by one's finger to stop flow out of the straw).

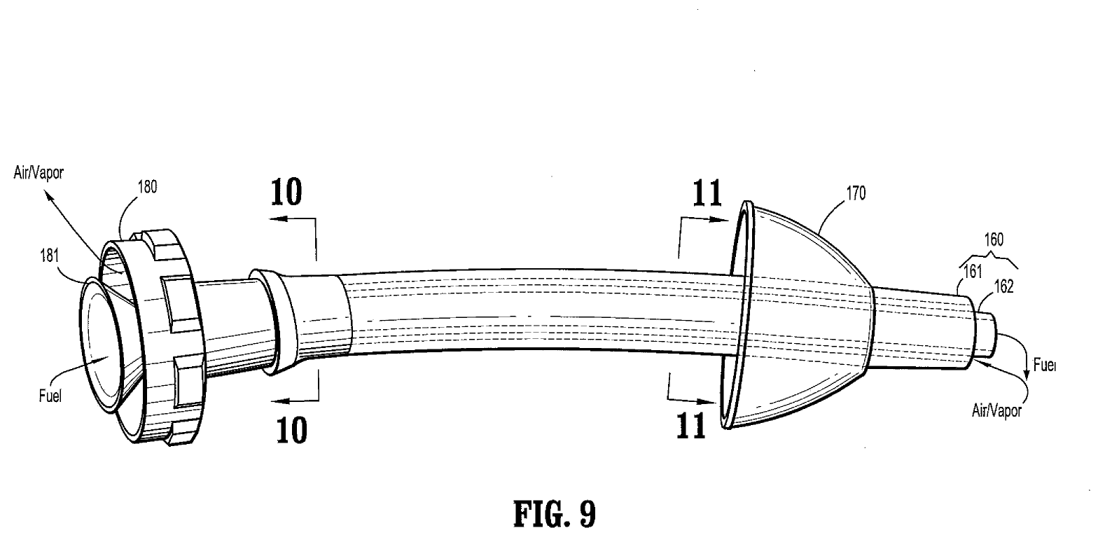

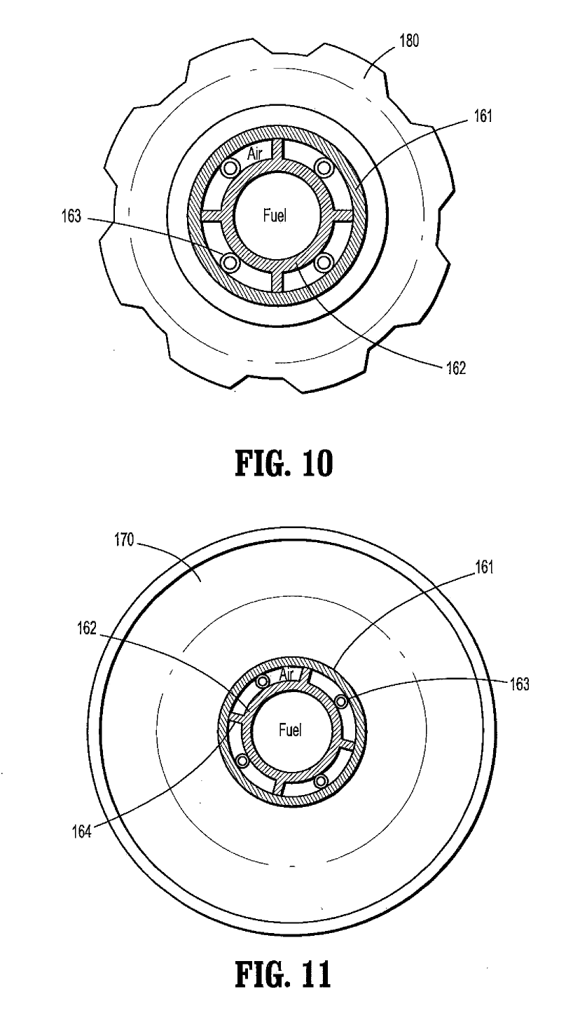

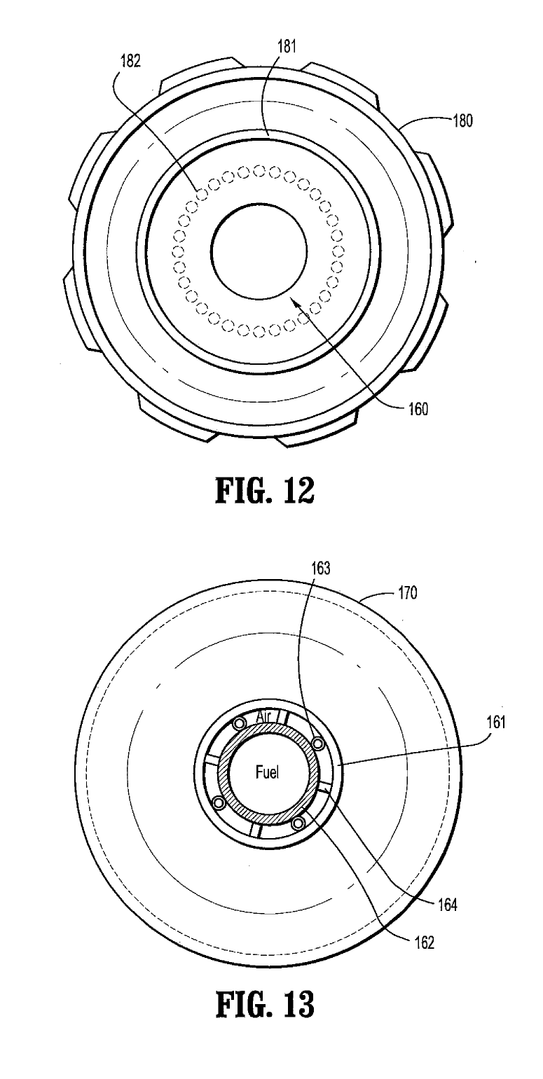

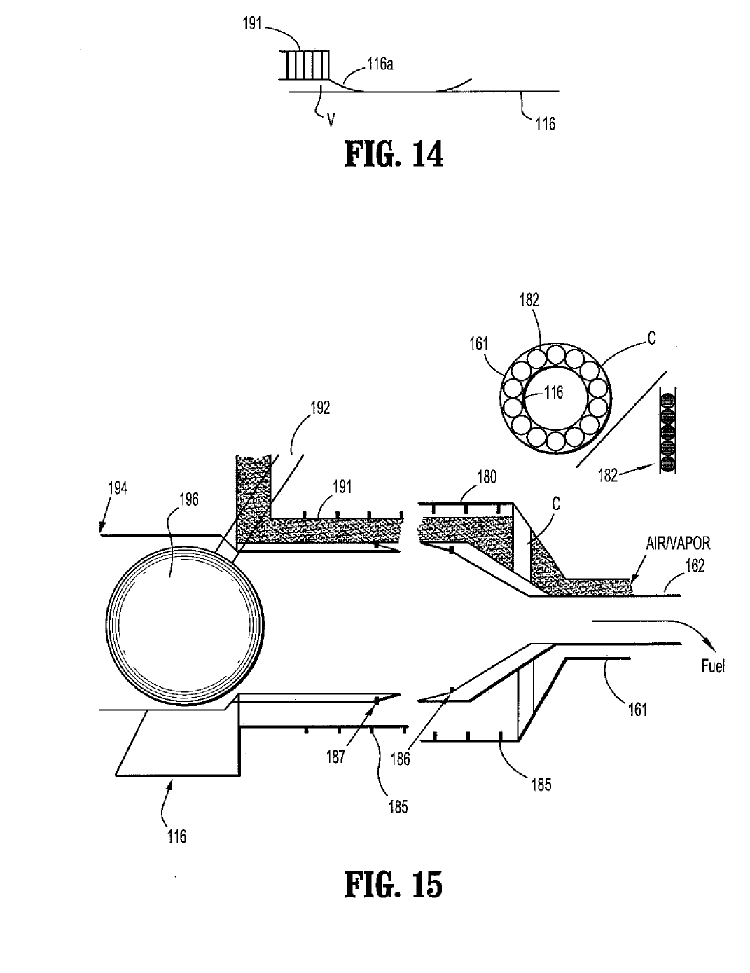

Depending on design constraints, the length of the outer hose 161 can be shortened from what is shown in FIG. 9 so that the outer hose 161 does not extend beyond the cone-shaped spout 170, and stops at or prior to the seal formed by the cone-shaped spout 170.

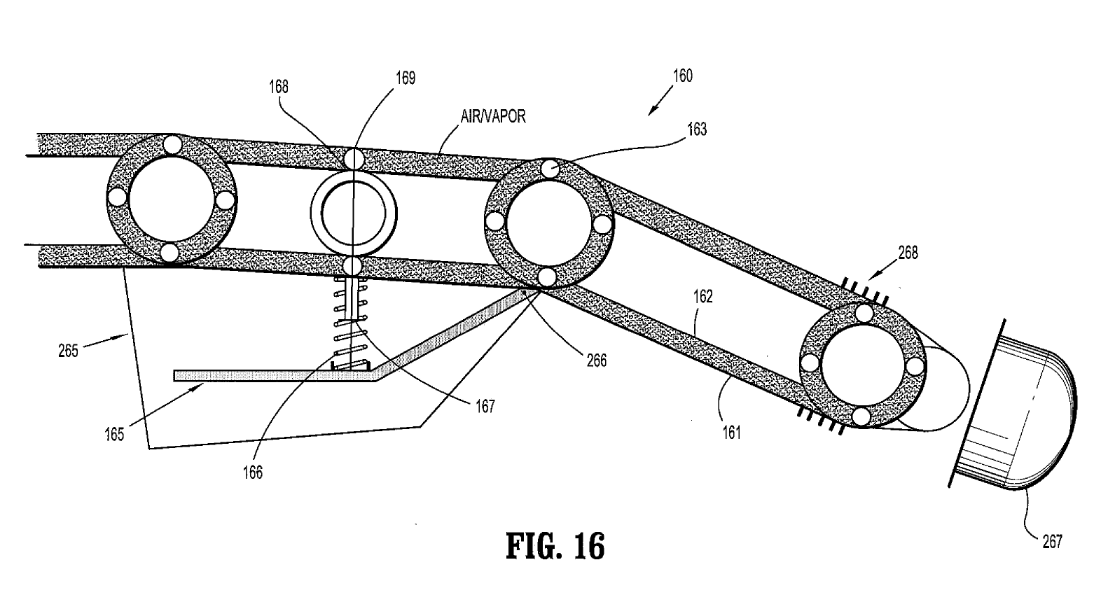

The delivery hose 160 may include a valve integrated therewith, such as, for example, a spring-loaded handle operated valve that is biased in the closed position. Referring, to FIG. 16, for example, a ball valve 168 is opened upon actuation of the handle 165 to allow free flow of fluid through the delivery hose 160. The valve 168 is biased by spring 166 in the closed position. When the handle 165 is pressed, the spring 166 is compressed, turning threaded bar 167, and moving ball valve 168 to the open position to allow fluid to flow through the hose 160. The valve system includes O-ring butterfly valve 169 adjacent the ball valve 168. The handle is moveable via a hinge 266. A guard 265 can be positioned around the handle 165 to prevent inadvertent pressing of the handle 165. In addition, a cap 267 may be secured to the dispensing end of the hose 160 using threads 268 so as to cover the dispensing end when not in use.

The side panel 112 also includes a ball valve positioned opposite the opening 191 on the inside portion of the housing 110. The ball valve includes a solid portion 194, an open portion 195 and a ball 196. The ball 196 sits in the solid portion 194 to block the fluid in the container from reaching the opening 191 when the container 100 is tipped. When a user desires to dispense fluid from the container 100, a blocking device 192, such as a bolt, penetrates through portion 193 into and through an opening in portion 194 to block the ball 196 from sealing off opening 191.

The side panel 112 also includes a ball valve at an upper portion thereof including a solid portion 198 and an open portion 199. Like the ball valve at the lower portion, when the container is tipped, a ball (not shown) sits in the portion 198 to seal off passage to canal 197 and prevent fluid from exiting the container 100 through the passageway 190. It is to be understood that other valves known to those of ordinary skill in the art may be used for the purpose of preventing fluid from exiting the container 100.

Although exemplary embodiments of the present invention have been described hereinabove, it should be understood that the present invention is not limited to these embodiments, but may be modified by those skilled in the art without departing from the spirit and scope of the present invention.

What is claimed is:

1. A fluid container, comprising:
a bottom surface;
four walls extending upward from the bottom surface to create a cavity to house a fluid;
a top surface covering the cavity;
a fluid opening formed in one of the four walls near the bottom surface, wherein the fluid passes through the fluid opening to exit the container; and
an air/vapor passageway formed adjacent and substantially parallel to the one of the four walls including the fluid opening, wherein the air/vapor passageway extends from the fluid opening upward toward the top surface, and air/vapor passes through the passageway into the container.

2. The fluid container as recited in claim 1, wherein the air/vapor passageway comprises an enclosed channel located on a surface of the one of the four walls, the enclosed channel including an entrance opening through which air/vapor enters the enclosed channel and an exit opening through which air/vapor exits the enclosed channel.

3. The fluid container as recited in claim 2, wherein the exit opening connects to a canal positioned at or near the top of the cavity and extending substantially parallel to the top surface, wherein the air/vapor travels through the canal into the cavity.

4. The fluid container as recited in claim 1, further comprising a hose connected to the fluid opening, wherein the hose includes:
an outer hose portion;
an inner hose portion substantially concentric with the outer hose portion; and
a space between an outer wall of the inner hose portion and an inner wall of the outer hose portion, wherein the fluid passes through the fluid opening to the inner hose portion, and the air/vapor passes through the space to the air/vapor passageway.

5. The fluid container as recited in claim 4, further comprising a plurality of spacers positioned between the outer and inner hose portions.

6. The fluid container as recited in claim 4, wherein the hose includes a dispensing end through which the fluid is dispensed, and a cone-shaped spout positioned at the dispensing end, wherein a smaller diameter portion of the cone-shaped spout is closer to the dispensing end than a larger diameter portion of the cone-shaped spout.

7. The fluid container as recited in claim 1, further comprising a valve to open and close the fluid opening.

8. The fluid container as recited in claim 7, wherein the valve is a ball valve.

9. The fluid container as recited in claim 1, wherein at least one of the four walls extends higher than the top surface and the portion of the at least one of the four walls higher than the top surface includes an opening formed therein.

10. The fluid container as recited in claim 1, further comprising a plurality of shoulder straps attached thereto to allow a user to wear the container on the user's back.

11. The fluid container as recited in claim 1, wherein the bottom surface extends beyond an outer surface of at least one of the four walls.

12. A fluid container, comprising:
a bottom surface;
four walls extending upward from the bottom surface to create a cavity to house a fluid;
a top surface covering the cavity;
a fluid opening formed in one of the four walls near the bottom surface, wherein the fluid passes through the fluid opening to exit the container; and
an air/vapor passageway formed along the one of the four walls including the fluid opening, wherein the air/vapor passageway extends from the fluid opening upward toward the top surface, and air/vapor passes through the passageway into the container.

13. The fluid container as recited in claim 12, wherein the air/vapor passageway connects to a canal positioned at or near the top of the cavity and extending substantially parallel to the top surface, wherein the air/vapor travels through the canal into the cavity.

14. The fluid container as recited in claim 12, further comprising a hose connected to the fluid opening, wherein the hose includes:
an outer hose portion;
an inner hose portion positioned in the outer hose portion; and
a space between an outer wall of the inner hose portion and an inner wall of the outer hose portion, wherein the fluid passes through the fluid opening to the inner hose portion, and the air/vapor passes through the space to the air/vapor passageway.
